(19) United States
(12) Patent Application Publication
(10) Pub. No.: US 2006/0106159 A1
(43) Pub. Date: May 18, 2006

(54) Coating compositions and articles coated therewith

(75) Inventors: Hiroto Ogawa, Toyota-shi (JP); Masaki Sakate, Ibaraki-shi (JP)

Correspondence Address: CONLEY ROSE, P.C., P. O. BOX 3267, HOUSTON, TX, 77253-3267, US

(73) Assignee: Kyowa Sangyo Co., LTD, Toyota-shi (JP)

(21) Appl. No.: 11/281,003

(22) Filed: Nov. 17, 2005

(30) Foreign Application Priority Data
Nov. 17, 2004 (JP) 2004-333120

(51) Int. Cl. C08G 18/08

(52) U.S. Cl. 524/589

(57) ABSTRACT

A coating composition is taught which 1) is essentially free of matting agents, 2) includes a two-package curing type acrylic urethane base resin that can form a coating film, which has a surface scratch hardness of 2H and a predetermined light transmittancy, and 3) includes 0.1% to 1.5% by weight of transparent particles having an average particle size of 5 μm to 30 μm. The coating film formed by the coating composition has a surface scratch resistance by means of the two-package curing type acrylic urethane, and is prevented from regular reflections generating images therearound by means of the transparent particles having an average particle size of 5 μm to 30 μm.

This application claims priority to Japanese patent application serial number 2004-333120, the contents of which are incorporated herein by reference.

### BACKGROUND OF THE INVENTION

1. Technical Field

The present invention relates to a coating composition and an article coated therewith and is applicable to parts in which a scratch resistance and a reduced reflection are required. Particularly, the present invention relates to a coating composition and an article coated therewith and is applicable to a window or a sun shade of a vehicle with a light transmittancy, for example.

2. Description of the Related Art

Resin, rubber, or elastomer materials are used, for example, in an interior of a vehicle since they are lightweight and offer various aesthetic properties to the interior. Specifically, such interior pieces include an instrument panel, a door trim panel, or the like. The surfaces of these panels are frequently formed soft and flexible, but at the same time it is preferable that the surface scratch resistance or the durability should be enhanced. Also, because of safety reasons, it is preferable that a surface within the view of a driver, such as a top surface of the instrument panel or a side panel surface near the windshield or the windows, should be prevented as much as possible from the regular reflections of the images therearound.

Therefore, there are various patent documents disclosing coating compositions, or articles coated therewith, which give or enhance a decorative feature and a scratch resistance for these surfaces, as well as preventing reflections from these surfaces.

For example, Japanese Laid-Open Publication No. 2003-292888 discloses a two-package type acrylic polyurethane coating composition used to form a coating film, which is low-gloss, scratch resistant, and discoloration resistant, on surfaces of vehicle interior parts. This coating composition includes a acrylic polymer and an isocyanate curing agent, as well as acrylic resin beads of 10 to 45 parts by weight to 100 parts by weight of solid content of the base resin so as to provide scratch resistance, discoloration resistance, and a gradation between glossy and matted finishings.

Japanese Laid-Open Publication No. 2000-296362 discloses a coated material for automobile parts, which is provided with a scratch resistance, an anti-glare, and also a soft texture or a decorative feature. This coated material includes two layers, one of which consists of at least a primer coating, the other consists of a beaded resin coating. The beaded resin coating consists of resin beads with thermal softening points of 120° C. to 200° C. The primer coating includes substances that have a better adhesiveness to both the automobile parts and the beaded resin.

When it comes to a vehicle windshield that is required to provide a forward visibility, or a see-through sun shade or sun visor that is intended also to secure a forward visibility, these articles should be formed to transmit visual information therethrough to the vehicle driver. Thus, these articles are required to have properties such as not only a scratch resistance or a reduced reflection as discussed above, but also an ability to transmit sufficient amounts of light or visible light. However, both the coating composition and the coated material mentioned above are only intended to give a scratch resistance and a reduced reflection, as well as decorative colors or glossy and matted finishings. They are not applicable to articles in which a light transmittancy is required.

### SUMMARY OF THE INVENTION

It is one object of the present invention to teach a coating composition and an article coated therewith that have a light transmittancy and can also give a scratch resistance and an reduced reflection to coated surfaces.

According to one aspect of the present teachings, a coating composition is taught which 1) is essentially free of matting agents, 2) includes a two-package curing type acrylic urethane base resin that can form a coating film, which has a surface scratch hardness of 2H and a predetermined light transmittancy, and 3) includes 0.1% to 1.5% by weight of transparent particles having an average particle size of 5 μm to 30 μm. It should be noted that a surface scratch hardness refers herein to a pencil hardness measured with a pencil method based on Japanese Industrial Standards K5600-5-4 (Testing methods for paints-Part 5: Mechanical property of film-Section 4: Scratch hardness (Pencil method)).

The coating film formed by the coating composition has a surface scratch resistance by means of the two-package curing type acrylic urethane, and is prevented from regular reflections, which generate images therearound, by means of the transparent particles having an average particle size of 5 μm to 30 μm. Furthermore, the coating composition allows the coating film to have a transparency and a reduced turbidity (sharpness of the images therethrough), because the coating composition includes the two-package curing type acrylic urethane base resin that has a predetermined light transmittancy and the transparent particles, and also because the coating composition is essentially free of a matting agent that causes turbidity.

It is preferable that the transparent particles are one or more types selected from the group consisting of polyurethane beads, acrylic beads, and polyurethane capsules, so that a transparent coating film with a greater surface scratch hardness is easily formed. Furthermore, it is possible to ensure so clear a visibility as to satisfy the requirements for driving a vehicle while giving a scratch resistance and a reduced reflection.

Regarding an article having parts with light transmittancy, when the surfaces of the parts are coated with such a coating composition, the article has a good surface scratch hardness and a well-reduced reflection. Furthermore, the light transmittancy of the parts are well-maintained.

It should be noted that the light transmittancy refers to an optical property in which at least a portion of visible light is transmitted.

According to the present invention, it is possible to provide a coating film with a surface scratch resistance, a reduced reflection, and a light transmittancy for an article coated with the present coating composition, so that the vehicle driver can obtain clearer visual information through the coating film and the article.

Additional objects, features and advantages of the present invention will be readily understood after reading the following detailed description.

### DETAILED DESCRIPTION OF THE INVENTION

Each of the additional features and teachings disclosed above and below may be utilized separately or in conjunction with other features and teachings to provide improved coating compositions and articles coated therewith. Representative examples of the present invention, which examples utilize many of these additional features and teachings both separately and in conjunction with one another, will now be described in detail. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

A coating composition of the present invention (herein referred to as the present coating composition) forms films on the surfaces of various articles, which are to be provided with a surface scratch resistance and a reduced reflection, by means of certain application or coating methods. Furthermore, when such an article has a optical property such as a transparency or a light transmittancy, it is preferable to provide a coating film of the present coating composition on the surface of the article because not only are a scratch resistance and a reduced reflection provided on the surface, but also the optical property of light transmittancy is maintained.

Articles to apply the present coating composition to may be made of various materials, which include, but are not limited to, various resin, rubber or elastomeric materials, glass materials, or metal materials. Also, the primer-applied surfaces of these materials may appropriately be coated with the present coating composition. Considering the reduced reflection property of the coated article, it is preferred that the article should be used in a vehicle interior such as a top surface of a dashboard or an instrument panel within the view of the driver while driving. Especially, the coating film of the present coating composition is desirable to articles in which a light transmittancy is required, because the coating film can maintain the light transmittancy of the articles. Examples of such articles include, but are not limited to, a windshield, side windows, and a light-transmittance sun visor. An example of such a sun visor includes a polycarbonate plastic molded article. Polycarbonate plastic articles are preferable because the present coating composition can be directly applied and is well-adhered to the articles.

The present coating composition is characterized by 1) being essentially free of matting agent, 2) including a two-package curing type acrylic urethane base resin that can form a coating film, which has a surface scratch hardness of 2H and a predetermined light transmittancy, and 3) including 0.1% to 1.5% by weight of transparent particles having an average particle size of 5 μm to 30 μm. As described above, it should be noted that a surface scratch hardness herein refers to a pencil hardness measured with a pencil method based on Japanese Industrial Standards K5600-5-4. Furthermore, an average particle size regarding transparent particles herein refers to a volume average particle size as measured by a laser diffraction particle size distribution analyzer “LA-500” manufactured by Horiba, Ltd., Japan.

Various coating base resins, which consist of polyacrylic polyols and polyisocyanates so that the acrylic urethane obtained with them is transparent, can be used as the two-package curing type acrylic urethane base resin. Also, various, well-known polyacrylic polyols that contain hydroxyl groups reactive with isocyanates, can be used as the polyacrylic polyols. Examples of the polyacrylic polyols include, but are not limited to, a polyacrylic polyol made from at least one or more monomers that are selected from the group of a (meth)acrylic acid, various (meth)acrylic acids containing hydroxyl groups, a (meth)acrylic acid alkyl ester, a (meth)acrylamide and its derivatives, a carboxylate ester of vinyl alcohol, an unsaturated carboxylic acid, and hydrocarbons having one or more unsaturated alkyl chains.

The polyisocyanate may be a compound having two or more isocyanate groups. Well-known isocyanate curing agents such as an aromatic isocyanate, an alicyclic isocyanate, and an aliphatic isocyanate, can be used as the polyisocyanate. Considering a light resistance or a transparency required for practical use, an aliphatic isocyanate such as hexamethylene diisocyanate or isophorone diisocyanate is preferable.

The two-package curing type acrylic urethane base resin may by itself form coating film surfaces having a scratch hardness of 2H or more. However, if the coating film surfaces have a scratch hardness of less than 2H, the surface may not be hard enough to realize a preferable surface scratch hardness.

The transparent particles having an average particle size of 5 μm to 30 μm are not specifically limited, as long as the articles are transparent. Well-known inorganic or organic beads can be used as the particles. Typically, they can be polyurethane resin beads, particles formed by transparent micro-capsules filled with polyurethane resins, or acrylic beads. The wall materials of the micro-capsules are not specifically limited but are preferable to be adhesive to the two-package curing type acrylic urethane base resin. For example, urethane resin micro-capsules can be used appropriately.

The transparent particles should have an average particle size of 5 μm to 30 μm. If the average particle size is less than 5 μm, irregular reflections will not be generated enough to realize a preferably reduced reflectivity. Conversely, if the average particle size is more than 30 μm, the images obtained through the coating film tend to be unclear or turbid. The average particle size is preferably 10 μm to 20 μm, and more preferably 10 μm to 15 μm, especially when the present coating composition is applied to vehicle parts that are to have a visibility through the coating film of the present coating composition. Such vehicle parts are required to allow lights or images, which form fields of view during the driving of the vehicle, to be transmitted through the parts.

The transparent particles to be loaded into the resin solution are 0.1% to 1.5% by weight based on the solid content of the coating composition. If the transparent particles are less than 0.1% by weight based on the solid contents, the reflectivity of the coating film tends to be greater or the scratch resistance tends to be reduced. Conversely, the transparent particles exceed 1.5% by weight based on the solid contents, the images obtained through the coating film tend to be unclear or turbid. Preferably, the transparent particles are 0.5% to 1.2%, especially when the present coating composition is applied to vehicle parts that are to have visibility through the coating film of the present coating composition.

The present coating composition is essentially free of matting agents. Such matting agents may be well-known, examples of which are well-known organic or inorganic matting agents including silk protein, polyethylene wax, talc, calcium carbonate, clay, kaolin, silica, and the like. By not including such matting agents, the images obtained through the coating film of the present coating composition can be well prevented from being unclear or turbid.

It should be noted that well-known submaterials may appropriately be added to the present coating composition. Examples of the submaterials include, but are not limited to, solvents, dispersing media, viscosity modifiers, stabilizers, and the like. Also, if organic beads are used as transparent particles, the beads may include dispersants, surfactants, and the like for forming the beads. Any of the submaterials should be used as far as a predetermined light transmittancy can be ensured by the present coating composition.

The present coating composition can form coating films of a predetermined thickness, typically by drying after the application or coating. Regarding the application and coating methods, well-known devices may be used such as roll coaters, flow coaters, or air-spray guns. Also, it is a matter of choice as to which well-known application or coating method such as spraying, rolling, or brushing should be applied. Furthermore, the coating composition may be prepared with a certain condition such as a viscosity desirable for a specific method of the aforementioned application or coating.

Preferably, a coating film obtained by the present coating composition has a reflectivity of 1.8% or less. If the reflectivity is 1.8% or less, images formed by the reflected light, or reflection, may not be perceived by the human eye. It should be noted that the reflectivity herein is measured by a method based on Japanese Industrial Standards K7105 (Testing Methods for Optical Properties of Plastics).

Preferably, a light transmittancy of the coating film of the present coating composition is 70% or more. Causing the light transmittancy of the coating film to be 70% or more makes it possible for the coated articles having a light transmittancy to reduce the reflection of a surface while maintaining the light transmittancy of the article.

The following example illustrates a representative coating composition and articles coated with the present coating composition.

### EXAMPLE

The present coating composition was prepared as follows. First, a two-package curing type acrylic urethane base resin was formulated by utilizing polyacrylic polyols “Silky Satin (P-8HN),” manufactured by Ohashi Chemical Industries, Ltd., Japan, and polyisocyanates “Polynal No. 800 Curing Agent IP-60,” manufactured by Ohashi Chemical Industries. Thereafter, transparent particles, which consist of urethane resin beads of 10 μm in average particle size were added to the base resin so that the transparent particle content was 1.0% by weight based on the solid content of the coating composition, thereby producing the present coating composition.

Articles coated with the present coating composition were obtained as follows. First, articles of polycarbonate plates of 0.5 to 3 mm in thickness were provided that had a light transmittancy of 2%. Then, the present coating composition was coated on both sides of the plates by means of air spraying application. Thereby, coating films of 10 to 30 μm were formed respectively on both sides of the plates.

The coated articles had surfaces with a scratch hardness of 2H, which means a sufficient scratch resistance. Also, the surfaces respectively had reflectivities of 1.7% to 1.8%. Furthermore, an evaluation by an organoleptic test demonstrated that the reflections were well-reduced. The coated articles allowed the obtaining of visual information across the thickness of the articles, or through the articles. Especially, according to the organoleptic test, the images were sharp and less turbid enough to obtain detailed visual information.

It should be understood that coated articles may be obtained by coating at least one part of the surface with the present coating composition. Thus, coated articles are not limited to articles coated on both sides as in the aforementioned preferred embodiment.

What is claimed is:

1. A coating composition, comprising:
a two-package curing type acrylic urethane base resin that can form a coating film, which has a surface scratch hardness of 2H and a predetermined light transmittancy; and
0.1% to 1.5% by weight of transparent particles having an average particle size of 5 μm to 30 μm,
wherein the coating composition is essentially free of matting agents.

2. The coating composition as in claim 1, wherein the transparent particles are one or more types selected from the group consisting of polyurethane beads, acrylic beads, and polyurethane capsules.

3. The coating composition as in claim 1, wherein the coating film has a reflectivity of 1.8% or less and a light transmittancy of 70% or more.

4. The coating composition as in claim 2, wherein the coating film has a reflectivity of 1.8% or less and a light transmittancy of 70% or more.

5. An article coated with the coating composition as in claim 1, wherein the article has one or more parts allowing a predetermined light transmittancy.

6. An article coated with the coating composition as in claim 2, wherein the article has one or more parts allowing a predetermined light transmittancy.

7. An article coated with the coating composition as in claim 3, wherein the article has one or more parts allowing a predetermined light transmittancy.

8. An article coated with the coating composition as in claim 4, wherein the article has one or more parts allowing a predetermined light transmittancy.

9. The article as in claim 5, wherein the article is made of polycarbonate plastic.

10. The article as in claim 6, wherein the article is made of polycarbonate plastic.

11. The article as in claim 7, wherein the article is made of polycarbonate plastic.

12. The article as in claim 8, wherein the article is made of polycarbonate plastic.

13. The article as in claim 5, wherein the article is a vehicle sun visor.

14. The article as in claim 6, wherein the article is a vehicle sun visor.

15. The article as in claim 7, wherein the article is a vehicle sun visor.

16. The article as in claim 8, wherein the article is a vehicle sun visor.
